(19) United States
(12) Patent Application Publication
(10) Pub. No.: US 2008/0287203 A1
(43) Pub. Date: Nov. 20, 2008

(54) Separable shaft coupler and transmission device using the same

(75) Inventor: Chuang-Hua Chueh, Hsinchu (TW)

Correspondence Address: BACON & THOMAS, PLLC, 625 SLATERS LANE, FOURTH FLOOR, ALEXANDRIA, VA, 22314-1176, US

(73) Assignee: AVISION INC., Hsinchu (TW)

(21) Appl. No.: 12/078,235

(22) Filed: Mar. 28, 2008

(30) Foreign Application Priority Data
May 16, 2007 (TW) 96117486

(51) Int. Cl. F16C 3/00; F16D 1/02

(52) U.S. Cl. 464/182; 403/375

(57) ABSTRACT

A separable shaft coupler for coupling a transmission shaft and a passive shaft in a transmission device includes a first plate and a second plate. The first plate is connected to the transmission shaft and has a protrusion. The second plate is connected to the passive shaft and has a concavity. When the transmission shaft is coupled to the passive shaft, the protrusion is received in the concavity so that the transmission shaft drives the passive shaft to rotate.

This application claims the benefit of Republic of Taiwan application Serial No. 96117486, filed May 16, 2007, the subject matter of which is incorporated herein by reference.

### BACKGROUND OF THE INVENTION

1. Field of the Invention

The invention relates in general to a separable shaft coupler and a transmission device using the same, and more particularly to a separable shaft coupler for coupling a transmission shaft to a passive shaft for the passive shaft to be driven by the transmission shaft and a transmission device using the same.

2. Description of the Related Art

The mechanism for rotary movement through axial transmission can be divided into separable type and non-separable type. There are many machines using axial transmission. Separable transmission devices are normally used in apparatus such as printers and copiers, for driving removable components like toner cartridges. Referring to FIG. 1A, a perspective view of a conventional separable transmission device is shown. The separable transmission device 100 has a transmission shaft 110 and a passive shaft 130, wherein the transmission shaft 110 has a transmission rod 150. The passive shaft 130 has a second plate 170 with a groove 170′. The transmission shaft 110 is engaged with the groove 170′ through the transmission rod 150 to drive the second plate 170 to rotate the passive shaft 130.

Referring to FIG. 1B, a perspective view of the conventional separable transmission device in FIG. 1A in an engaging state is shown. The groove 170′ has a distance H170′ larger than the diameter D150 of the transmission rod 150 so that the transmission rod 150 can be disposed inside the groove 170′. However, such design results in backlash during transmission. When the transmission shaft 110 rotates in a rotary direction ψ, the backlash B110 will cause the transmission rod 150 to rotate idly before driving the passive shaft 130 to rotate 130. As the backlash B110 has a component in the rotary direction ψ, a part of energy transmitted will be wasted when the transmission shaft 110 rotates to drive the passive shaft 130. If the distance H170′ is reduced to be slightly larger than the diameter D150, the operator assembling the device would have difficulty the assembly. Moreover, the second plate 170 has a bending angle 171, and a reduced distance H170′ would easily cause the passive shaft 130 to be displaced from the center of the transmission shaft 110 during assembly. Thus, the bending angle 171 will obstruct the operation.

### SUMMARY OF THE INVENTION

The invention relates to a separable shaft coupler and a transmission device using the same. The separable shaft coupler is provided with at least a protrusion and a concavity. As the protrusion and the concavity are tightly coupled together in a rotation direction, there is no backlash during rotation.

According to a first aspect of the present invention, a separable shaft coupler for coupling a transmission shaft and a passive shaft is provided. The separable shaft coupler includes a first plate and a second plate. The first plate includes a protrusion projected from one surface of the first plate. The other surface of the first plate is connected to a first end of the transmission shaft. The second plate has a concavity formed on one surface of the second plate. The other surface of the second plate is connected to a second end of the passive shaft. When the transmission shaft is coupled to the passive shaft, the protrusion is received in the concavity so that the transmission shaft drives the passive shaft to rotate. When the transmission shaft is not coaxial with the passive shaft, the flexibility of the first plate and the accommodating space provided by the concavity will enable the device to function smoothly.

According to a second aspect of the present invention, a separable transmission device including a transmission shaft, a passive shaft, a first plate and a second plate is provided. The transmission shaft has a first end. The first plate includes a protrusion projected from one surface of the first plate. The other surface of the first plate is connected to a first end of the transmission shaft. The passive shaft has a second end. The second plate has a concavity formed on one surface of the second plate. When the transmission shaft is coupled to the passive shaft, the protrusion is received in the concavity so that the transmission shaft drives the passive shaft to rotate.

The invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a perspective view of a conventional separable transmission device;

FIG. 1B (Prior Art) is a perspective view of the conventional separable transmission device in FIG. 1A in an engaging state;

FIG. 2A is a perspective view of a separable transmission device according to a preferred embodiment of the invention;

FIG. 2B is a partial enlargement of the protrusion in FIG. 2A received at a first position;

FIG. 2C is a partial enlargement of the protrusion in FIG. 2A received at a second position;

FIG. 3A is a cross-sectional view of the separable transmission device in FIG. 2A in an engaging state along a transmission tangent direction;

FIG. 3B is a cross-sectional view of the separable transmission device in FIG. 2A in an engaging state along the direction of a line extending from the central point;

FIG. 4A is a perspective view of the passive shaft and the transmission shaft in FIG. 3A forming an angle eccentrically between each other; and

FIG. 4B is a perspective view of the coupling surface between the protrusion and the concavity in the present embodiment of the invention.

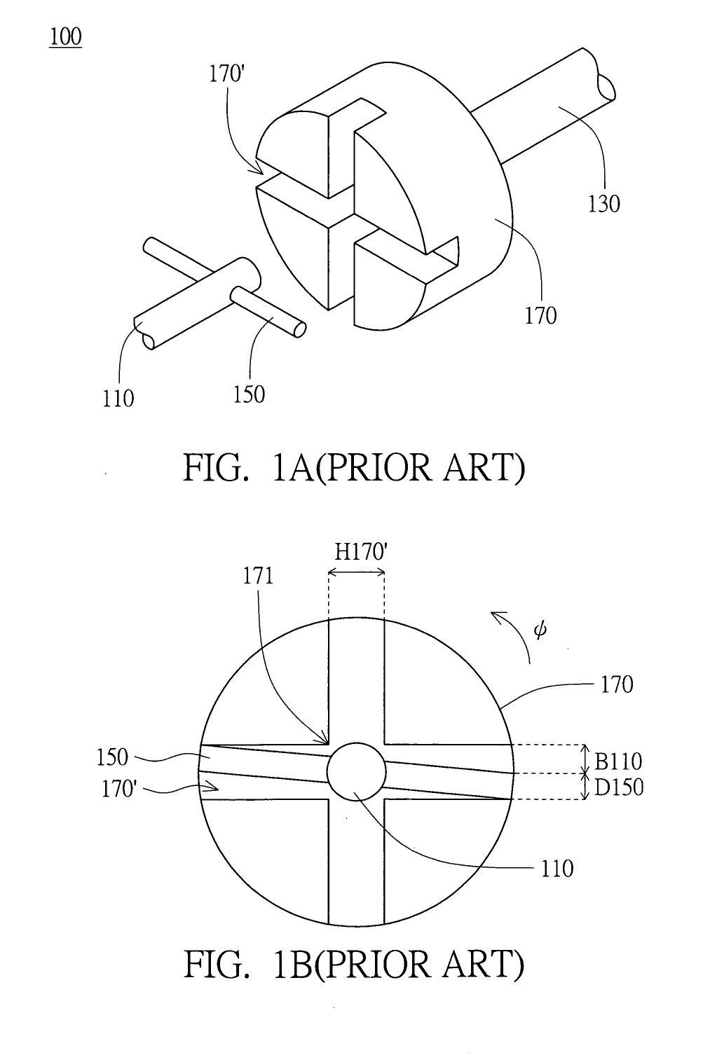

### DETAILED DESCRIPTION OF THE INVENTION

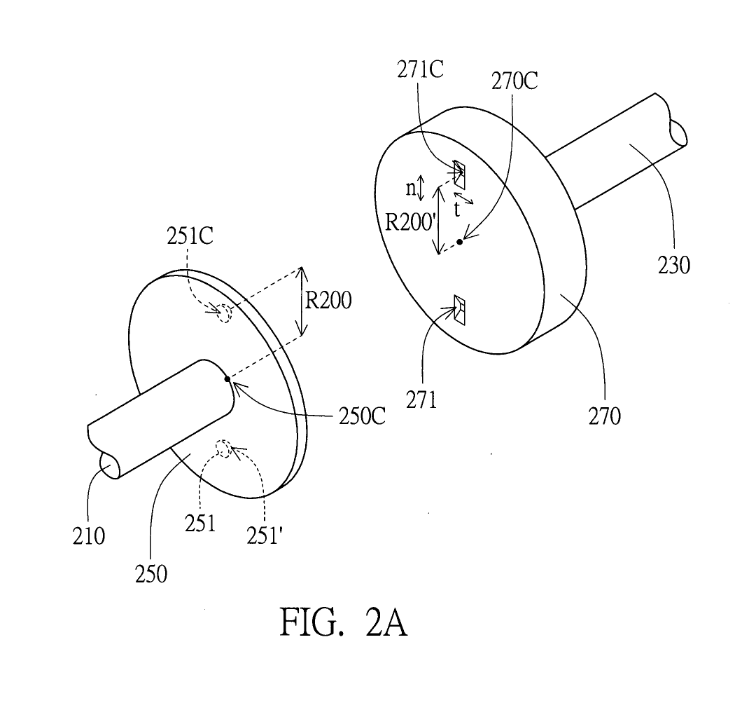

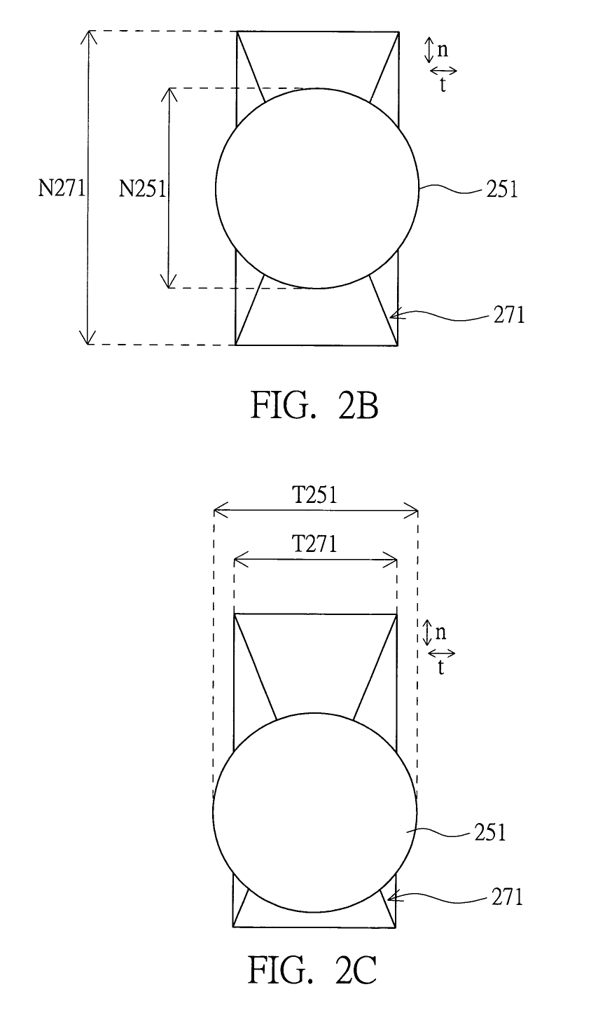

Referring to FIG. 2A, a perspective view of a separable transmission device according to a preferred embodiment of the invention is shown. Also referring to FIG. 2B and FIG. 2C, FIG. 2B is a partial enlargement of the protrusion in FIG. 2A received at a first position, and FIG. 2C is a partial enlargement of the protrusion in FIG. 2A received at a second position. The separable transmission device 200 includes a transmission shaft 210, a passive shaft 230, a first plate 250 and a second plate 270. The first plate 250 includes a protrusion 251 projected from one surface of the first plate 250. The other surface of the first plate 250 is connected to a first end of the transmission shaft 210. The second plate 270 has a concavity 271 formed on one surface of the second plate 270. The other surface of the second plate 270 is connected to a second end of the passive shaft 230. When the transmission shaft 210 is coupled to the passive shaft 230, the protrusion 251 is received in the concavity 271 so that the transmission shaft 210 drives the passive shaft 230 to rotate.

On the other hand, in the separable transmission device 200 of the present embodiment of the invention, the minimum length N271 of the concavity 271 in the direction n of the line extending from the central point 271C to the central point 270C of the second plate 270 is slightly larger than the maximum diameter N251 of the protrusion in the direction n of the extended line as indicated in FIG. 2B. The maximum width T271 of the concavity 271 in the rotation tangent direction t is slightly smaller than the maximum diameter T251 of the protrusion 251 in the rotation tangent direction t as indicated in FIG. 2C. When the transmission shaft 210 coaxially drives the passive shaft 230 to rotate, the protrusion 251 is received at a first position of the concavity 271 as indicated in FIG. 2B. When the transmission shaft 210 non-coaxially drives the passive shaft 230 to rotate, the protrusion 251 is received at a second position as indicated in FIG. 2C. The first plate 250 is preferably a round-shaped sheet coaxial with the transmission shaft 210. The protrusion 251 preferably has a spherical surface 251′. There is a first distance R200 from the central point of 251C of the protrusion 251 to the central point of 250C of the first plate 250. Besides, the second plate 270 is preferably a round-shaped second plate 270 coaxial with the passive shaft 230. There is a second distance R200′ from the central point of 271 C of the concavity 271 to the central point of 270C of the second plate 270. The second distance R200′ is substantially equal to the first distance R200. Moreover, the protrusion 251 disposed on the first plate 250 corresponds to the concavity 271 disposed on the second plate 270. When the transmission shaft 210 rotates, each protrusion 251 is tightly received in a corresponding concavity 271, so that the concavity 271 drives the passive shaft 230 to rotate by the protrusion 251.

In details, the separable transmission device 200 enables the transmission shaft 210 to drive the passive shaft 230 to rotate through at least a protrusion 251 and at least a concavity 271. In the present embodiment of the invention, two protrusions 251 and two concavities 271 are used for elaboration. However, any one who is skilled in the technology of the invention will understand that the technology of the invention is not limited thereto. The number of the protrusions 251 should not be greater than that of the concavities 271. The protrusions may differ in their distances to the central point of the first plate 250, and so may the concavities differ in their distances to the central point of the round-shaped disc. The invention is applicable as long as the distance from each protrusion to the central point of the first plate 250 is substantially equal to the distance from the corresponding concavity to the central point of the round-shaped disc so that when the transmission shaft 210 drives the passive shaft 230 to rotate, each protrusion is received in its corresponding concavity.

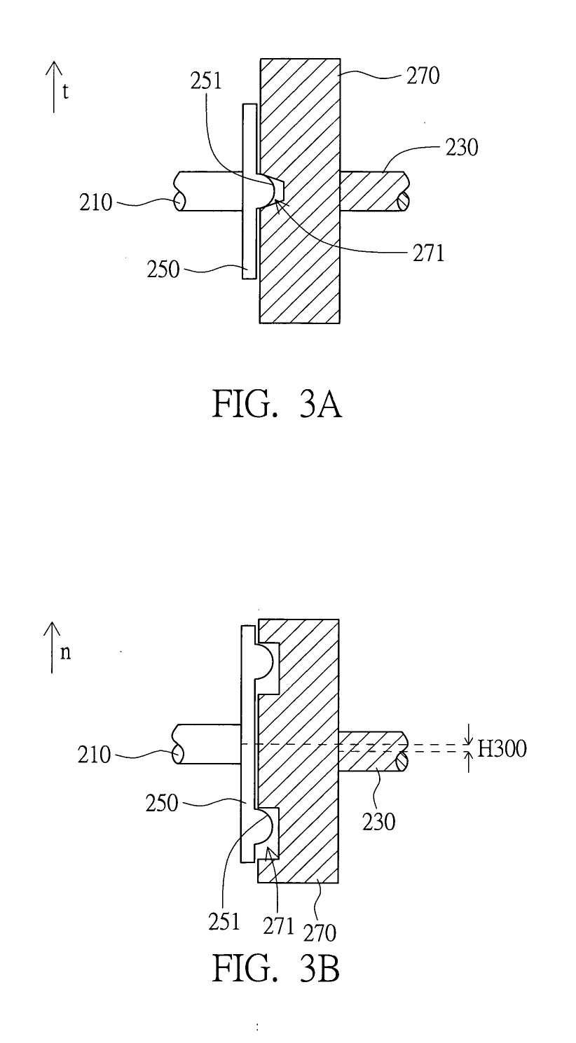

Referring to FIG. 3A and FIG. 3B, FIG. 3A is a cross-sectional view of the separable transmission device in FIG. 2A in an engaging state along a transmission tangent direction, and FIG. 3B is a cross-sectional view of the separable transmission device in FIG. 2A in an engaging state along the direction of a line extending from the central point. The passive shaft 230 is coupled to the protrusion 251 through the concavity 271, despite in the direction of the rotation tangent t. Even when a displacement length H300 is created between the passive shaft 230 and the transmission shaft 210 in the direction n of a line extending from the central point, the protrusion 251 still tightly leans against the concavity 271 and is received at a second position of the concavity 271 so that the transmission shaft 210 still can drive the passive shaft 230 to rotate without generating any backlashes. As indicated in FIGS. 3A and 3B, the deflection in the direction n of the extended line does not affect the transmission shaft 210 rotating on the rotation tangent direction t nor causing backlash in the rotation tangent direction t, so that the separable transmission device 200 of the present embodiment of the invention can rotate normally. The relative position between the protrusion 251 and the concavity 271 being coaxial or non-coaxial is illustrated in the partial enlargement diagrams of FIGS. 2B and 2C. As indicated in FIG. 2B, when the protrusion 251 and the concavity 271 are coaxial, the protrusion 251 and the concavity 271 will be jointed at a first position. As indicated in FIG. 2C, when the protrusion 251 and the concavity 271 are not coaxial, the protrusion 251 and the concavity 271 will be jointed at a second position. The present embodiment of the invention not only achieves rotation without generating any backlashes but also achieves transmission even when two axial shafts jointed together are not coaxially positioned.

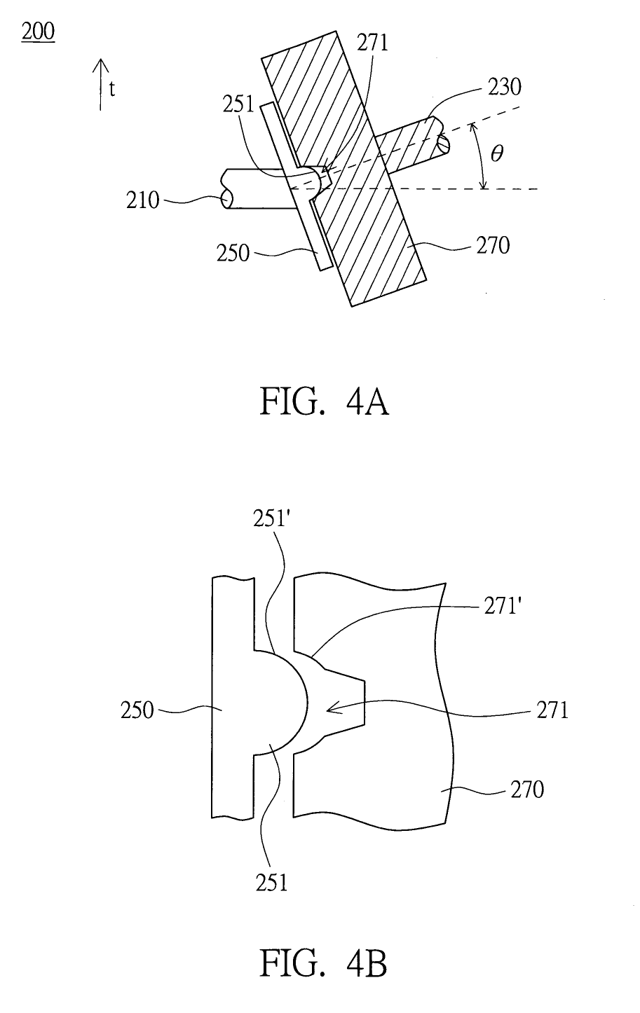

Also, referring to FIG. 4A, a perspective view of the passive shaft and the transmission shaft in FIG. 3A forming an angle between each other is shown. Let an angle θ be created between the passive shaft 230 and the transmission shaft 210. As the first plate 250 adopted in the present embodiment of the invention provides a deflection, the protrusion 251 having a spherical surface 251′ will still be tightly received in the concavity 271 in the direction of the rotation tangent t so that the separable transmission device 200 still functions normally. Thus, when the separable transmission device 200 is disassembled and the two axes are accidentally misaligned or not parallel to each other, the separable transmission device 200 still functions normally. Any one who is skilled in the technology of the invention will understand that the technology of the invention is not subjected to the restriction that the two axes must have a displacement length H300 or an angle θ. The two axes being coaxial also assure normal operation of the separable transmission device 200 of the present embodiment of the invention.

With respect to the protrusion 251 being received in the concavity 271 for driving purpose, referring to FIG. 4B, a perspective view of the coupling surface between the protrusion and the concavity in the present embodiment of the invention is shown. The concavity 271 has an inner surface 271′, which enables the spherical surface 251′ of the protrusion 251 to have a larger contact area with the concavity 271, so that the transmission shaft 210 drives the passive shaft 230 to rotate with efficiency. In addition to changing the inner surface 271′ of the concavity 271 to improve transmission effect, the protrusion 251 and the concavity 271 can also increase the frictional force at the contact point/surface between the protrusion 251 and the concavity 271 by applying pattern treatment or using a material of a high friction coefficient. The surface of the protrusion 251 can also be a conical surface, and the concavity 271 can be a through hole of the second plate 270. Besides, if the deflected first plate 250 is a round-shaped thin steel sheet, the protrusion 251 can be directly formed on the steel sheet by way of stamping for example.

According to the separable transmission device disclosed in the preferred embodiment of the invention, a protrusion on the first plate is coupled to a concavity on the second plate for driving purpose, and no backlash is generated in the rotation direction between the concavity and the protrusion, hence reducing the energy loss during transmission. Moreover, for the transmission device frequently disassembled, the invention also provides a tolerance to the operator who performs the activity. When two axes are not coaxial, the concavity still provides an accommodating space for the protrusion to be tightly coupled to the concavity, and the first plate provides a tolerance for allowing the separable transmission device of the invention to function normally even when an angle is created between the two plates.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A separable shaft coupler for coupling a transmission shaft to a passive shaft, the separable shaft coupler comprising:
a first plate having a protrusion projected from one surface of the first plate, and an other surface of the first plate is connected to a first end of the transmission shaft; and
a second plate having a concavity formed on one surface of the second plate, and an other surface of the second plate is connected to a second end of the passive shaft;
wherein when the transmission shaft is coupled to the passive shaft, the protrusion is received in the concavity so that the transmission shaft drives the passive shaft to rotate.

2. The separable shaft coupler according to claim 1, wherein a direction of the line extending from a central point of the second plate to a central point of the concavity defines a first direction, a tangent direction that the central point of the concavity rotates around the central point of the second plate defines a second direction, a maximum width of the concavity along the second direction is shorter than a maximum diameter of the protrusion along the second direction, and a minimum length of the concavity along the first direction is longer than a maximum diameter of the protrusion along the first direction;
wherein when the transmission shaft coaxially drives the passive shaft to rotate, the protrusion is received in a first position of the concavity, and when the transmission shaft non-coaxially drives the passive shaft to rotate, the protrusion is received in a second position of the concavity.

3. The separable shaft coupler according to claim 1, wherein the first plate is a round-shaped sheet coaxial with the transmission shaft.

4. The separable shaft coupler according to claim 3, wherein the second plate is a round-shaped disc coaxial with the passive shaft.

5. The separable shaft coupler according to claim 4, wherein a distance from a central point of the protrusion to the central point of the round-shaped sheet defines a first distance, and a distance form the central point of the concavity to the central point of the round-shaped disc defines a second distance substantially equal to the first distance.

6. The separable shaft coupler according to claim 1, wherein the protrusion has a conical surface.

7. The separable shaft coupler according to claim 1, wherein the protrusion has a spherical surface.

8. The separable shaft coupler according to claim 1, wherein a surface of the protrusion is coated with a friction enhancing material.

9. The separable shaft coupler according to claim 1, wherein an inner surface of the concavity is coated with a friction enhancing material.

10. The separable shaft coupler according to claim 1, wherein the second plate has a plurality of concavities.

11. The separable shaft coupler according to claim 10, wherein the first plate comprises a plurality of protrusions, and when the transmission shaft is coupled to the passive shaft, the protrusions are respectively received in the corresponding concavities.

12. The separable shaft coupler according to claim 11, wherein a number of the protrusions is at most equal to a number of the concavities.

13. A separable transmission device, comprising:
a transmission shaft having a first end;
a first plate comprising a protrusion projected from one surface of the first plate, and an other surface of the first plate is connected to the first end;
a passive shaft having a second end; and
a second plate having a concavity formed on one surface of the second plate, and an other surface of the second plate is connected to the second end;
wherein when the transmission shaft is coupled to the passive shaft, the protrusion is received in the concavity so that the transmission shaft drives the passive shaft to rotate.

14. The separable transmission device according to claim 13, wherein the direction of the line extending from a central point of the second plate to a central point of the concavity defines a first direction, a tangent direction that the central point of the concavity rotates around the central point of the second plate defines a second direction, a maximum width of the concavity along the second direction is shorter than a maximum diameter of the protrusion along the second direction, and a minimum length of the concavity along the first direction is longer than a maximum diameter of the protrusion along the first direction;
wherein when the transmission shaft coaxially drives the passive shaft to rotate, the protrusion is received in a first position of the concavity, and when the transmission shaft non-coaxially drives the passive shaft to rotate, the protrusion is received in a second position of the concavity.

15. The separable transmission device according to claim 13, wherein the first plate is a round-shaped sheet coaxial with the transmission shaft.

16. The separable transmission device according to claim 15, wherein the second plate is a round-shaped disc coaxial with the passive shaft.

17. The separable transmission device according to claim 16, wherein a distance from a central point of the protrusion to the central point of the round-shaped sheet defines a first distance, and a distance from the central point of the concavity to the central point of the round-shaped disc defines a second distance substantially equal to the first distance.

18. The separable transmission device according to claim 13, wherein the protrusion has a conical surface.

19. The separable transmission device according to claim 13, wherein the protrusion has a spherical surface.

20. The separable transmission device according to claim 13, wherein a surface of the protrusion is coated with a friction enhancing material.

21. The separable transmission device according to claim 13, wherein an inner surface of the concavity is coated with a friction enhancing material.

22. The separable transmission device according to claim 13, wherein the second plate has a plurality of concavities.

23. The separable transmission device according to claim 22, wherein the first plate comprises a plurality of protrusions, and when the transmission shaft is coupled to the passive shaft, the protrusions are respectively received in corresponding concavities.

24. The separable transmission device according to claim 23, wherein a number of the protrusions is at most equal to a number of the concavities.
